(19) United States
(12) Patent Application Publication
(10) Pub. No.: US 2015/0043700 A1
(43) Pub. Date: Feb. 12, 2015

(54) METHOD AND SYSTEM FOR TARGET INJECTION USING A GAS-BEARING INJECTION BARREL

(71) Applicant: LAWRENCE LIVERMORE NATIONAL SECURITY, LLC, Livermore, CA (US)

(72) Inventors: Paul Rosso, Livermore, CA (US); Richard C. Montesanti, Pleasanton, CA (US)

(21) Appl. No.: 14/385,485

(22) PCT Filed: Jul. 17, 2013
(86) PCT No.: PCT/US13/50838

§ 371 Date: Sep. 15, 2014

Related U.S. Application Data
(60) Provisional application No. 61/673,380, filed on Jul. 19, 2012.

(51) Int. Cl. G21B 1/15

(52) U.S. Cl. CPC G21B 1/15
USPC 376/101

(57) ABSTRACT

A permeable barrel for accelerating a projectile is provided. The barrel includes a plurality of holes through which gas can be injected to generate a gas cushion for the projectile. The gas cushion prevents any contact between the projectile and the barrel walls. Also the gas cushion helps to keep the projectile centered in the barrel throughout its travel.

### CROSS-REFERENCES TO RELATED APPLICATIONS

This application claims priority to U.S. Provisional Patent Application No. 61/673,380, filed on Jul. 19, 2012, and entitled “Method and System for Target Injection using a Gas-Bearing Injection Barrel,” the disclosure of which is hereby incorporated by reference in its entirety for all purposes. This application is related to (a) U.S. Provisional Application No. 61/411,390, filed on Nov. 8, 2010, (b) U.S. Provisional Application No. 61/425,198, filed on Feb. 1, 2011 and (c) PCT Application No. PCT/US2011/059791, filed on Nov. 8, 2011.

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

Precise alignment and positioning of a target in a fusion reaction chamber is important in order to ensure that maximum energy is transferred to the target in order to start and sustain a fusion reaction.

In order to ensure that the target enters the fusion chamber at the desired velocity in a desired condition; the travel path of the target needs to be designed precisely. Despite progress being made in methods and systems for target injection and delivery, there is a need in the art for more improved method and systems for target injection and delivery.

### SUMMARY OF THE INVENTION

Embodiments of the present invention relate to techniques for ensuring that the target enters the fusion chamber at the desired velocity and with little to no degradation in order for an optimal fusion reaction to occur. Specifically, embodiments of the present invention provide a barrel through which the fusion target travels before it enters the fusion chamber.

Techniques disclosed herein provide various means for transporting the target through the barrel with little to no contact with the barrel internal walls thus preventing degradation of the target or barrel. The degradation of the target can include heating of the target and deposition of target material onto the inner walls of the barrel due to friction.

According to embodiments of the present invention, methods and systems are provided to launch a projectile from a barrel without contacting the barrel wall via gas flow through the barrel wall to create a gas-bearing effect. Embodiments of the present invention are well suited for fusion energy applications in which the projectiles are fusion energy fuel targets (see, for example, FIG. 1). As described herein, a tracking system can communicate with the injection process, the barrel may interface with a breech system, which may be pressurized to provide propellant gas, the barrel may interface with a projectile loading mechanism, and the barrel may interface such that one end of the barrel is connected to a high pressure chamber with the opposite end connected to a low pressure environment causing the projectile to travel toward and be launched into the low pressure environment.

As described herein the barrel can be characterized by a variety of enabling features, including a barrel wall that may include porous media (see, for example, FIG. 12). The porous characteristics may vary along barrel length to account for changing velocity, the barrel wall may consist of idealized orifice positions (see, for example, FIG. 2), the orifice count and/or size may vary along barrel length to account for changing velocity, the barrel wall may be perforated material, the perforation details may vary along barrel length to account for changing velocity, the barrel wall may additionally have a varying cross-section (see, for example, FIGS. 9A and 9B). The variation in barrel wall cross-section may provide variation in gas film thickness with respect to the projectile to account for changing velocity and to induce projectile rotation for gyroscopic stabilization.

In some embodiments, the flow through the barrel wall may be oriented to induce projectile rotation for gyroscopic stabilization. (see, for example, FIG. 8). The barrel may additionally include pressure regulation, which can be a passive or an active regulation system and the regulation pressure may vary along the barrel length. As an example, the regulation may vary along barrel length to affect the projectile acceleration profile. The cross-section of barrel may include portions of pressure supply and separate portions of pressure exhaust. (see, for example, FIG. 3). The barrel may additionally include means of active pressure control which follows along with projectile motion (see, for example, FIG. 5 and FIG. 11). The gas cushion may only be active in regions of the barrel containing the projectile (see, for example, FIG. 4) or the gas cushion could be tailored to account for projectile velocity (see, for example, FIG. 6). In some embodiments, additional pressure may be injected aft of projectile to provide propulsion. (see, for example, FIG. 7). Additionally, the barrel may have features to communicate pressure along barrel wall. (see, for example, FIG. 10)

According to an embodiment of the present invention, a method for transporting a projectile through a barrel having a length is provided. The method includes inserting the projectile into the barrel and flowing a gas into the barrel to generate an gas-film cushion around the projectile.

According to a particular embodiment of the present invention, a method of transporting an object along a tube structure having a tube wall is provided. The tube structure can also be referred to as a barrel. The method includes flowing a gas into the tube structure through the tube wall and generating a gas-film cushion between the object and the tube wall. The method also includes exhausting the gas from the tube structure through the tube wall.

According to another embodiment of the present invention, a system for accelerating a projectile through a barrel is provided. The system includes a barrel having a wall including gas flow passages operable to communicate gas along an interior portion of the barrel and to create a gas-film bearing and a pressurized gas system coupled to the barrel and operable to accelerate the projectile through the barrel.

According to yet another embodiment of the present invention, a method for transporting a target through a barrel having a length is provided. The method includes detecting insertion of the target into the barrel and determining a first position of the target in the barrel. The method also includes injecting a gas at the first position to generate an air cushion around the target and determining that the target has reached a second position in the barrel. The method further includes exhausting the gas at the first position and injecting the gas at the second position.

According to a specific embodiment of the present invention, a system for transporting a target through a barrel is provided. The system includes a perforated barrel and a target injection system operable to inject the target into the perforated barrel. The system also includes a target tracking system operable to measure a position of the target in the perforated barrel and a gas control system in fluid communication with the perforated barrel.

According to another specific embodiment of the present invention, a permeable barrel for accelerating a projectile is provided. The barrel includes a plurality of holes through which gas can be injected to generate a gas cushion for the projectile. The gas cushion prevents any contact between the projectile and the barrel walls. Also the gas cushion helps to keep the projectile centered in the barrel throughout its travel.

In another embodiment, a perforated barrel for transporting a target is provided. The barrel includes a plurality of holes through which gas can be injected to generate a gas cushion for the target. The gas cushion prevents any contact between the target and the barrel walls. Also the gas cushion helps to keep the target centered in the barrel throughout its travel.

These and other embodiments of the invention along with many of its advantages and features are described in more detail in conjunction with the text below and attached figures.

### BRIEF DESCRIPTION OF THE DRAWINGS

FIG. 1 illustrates a simplified system showing target injection and transport mechanisms according to an embodiment of the present invention.

FIG. 2 illustrates a perforated barrel with a net positive gas flow effect according to an embodiment of the present invention.

FIG. 3 illustrates a perforated barrel with a net zero gas flow effect according to an embodiment of the present invention.

FIG. 4 is a cross-sectional view of a barrel that illustrates on-time gas cushion generation according to an embodiment of the present invention.

FIG. 5 is a flow diagram of a process for generating a gas cushion according to an embodiment of the present invention.

FIG. 6 is a cross-sectional view of a barrel that illustrates creation of a gas cushion in front of a target according to an embodiment of the present invention.

FIG. 7 is a cross-sectional view of a barrel that illustrates generation of a pulsed gas cushion according to an embodiment of the present invention.

FIG. 8 is a cross-sectional view of a barrel having an angled groove design according to another embodiment of the present invention.

FIG. 9A illustrates a twisted barrel according to an embodiment of the present invention.

FIG. 9B is a schematic diagram illustrating a target as it travels through the twisted barrel of FIG. 9A according to an embodiment of the present invention.

FIG. 10A illustrates a mechanism to use propellant gas to generate a gas cushion for the target according to an embodiment of the present invention.

FIG. 10B illustrates another mechanism to use propellant gas to generate a gas cushion for the target according to another embodiment of the present invention.

FIG. 10C illustrates yet another mechanism to use propellant gas to generate a gas cushion for the target according to yet another embodiment of the present invention.

FIG. 11 is a simplified block diagram of a system for transporting a target according to an embodiment of the present invention.

FIG. 12 shows a CFD gas pressure plot of a porous media barrel and target interaction according to an embodiment of the present invention.

### DETAILED DESCRIPTION OF SPECIFIC EMBODIMENTS

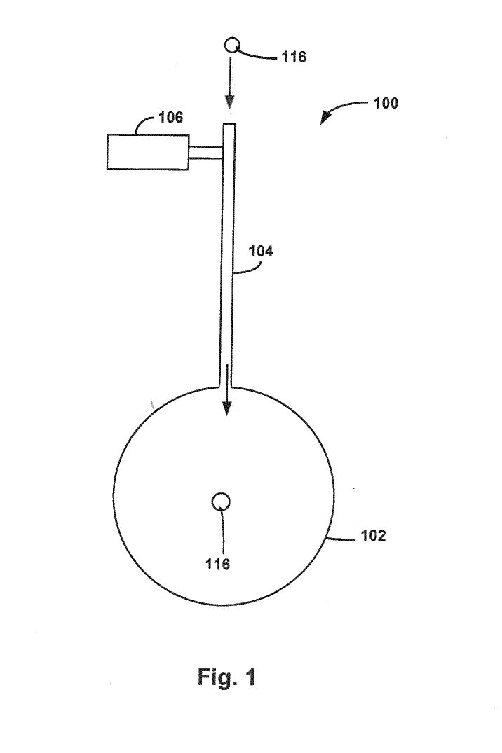

FIG. 1 is a simplified schematic illustrating a system 100 according to an embodiment of the present invention. System 100 includes a fusion chamber 102. A target injection barrel 104 is coupled to fusion chamber 102. A fusion target 116 is loaded from a distal end of barrel 104 and travels through barrel 104 and enters fusion chamber 102. A target injection mechanism 106 may be used to accelerate target 116 through barrel 104 in order to achieve a predetermined velocity for target 116 as it enters fusion chamber 102. Although some embodiments are described in the context of a fusion chamber application, the present invention is not limited to this particular application and embodiments of the present invention are also applicable to a variety of applications including, without limitation, object transportation systems and the like. One of ordinary skill in the art would recognize many variations, modifications, and alternatives.

It will be appreciated that the system configurations and components described herein are illustrative and that variations and modifications are possible. Further, while the system is described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of devices including electronic devices implemented using any combination of circuitry and software.

It is to be noted that FIG. 1 is a simplified schematic of fusion reaction system. One skilled in the art will realize that there are many more systems/components that may be needed to make system 100 work. However, these additional systems and components are not illustrated and/or described herein for sake of brevity.

As the target travels through barrel 104, it is beneficial to keep the target as centered as possible within the barrel so that the target does not touch the inner walls of barrel 104. In some embodiments, barrel 104 may be up to 10 meters long, which provides ample opportunities for the target to touch the inner walls of barrel 104. Since the target is being accelerated to very high values (e.g., between 4000 and 10,000 m/s²) as it travels through the barrel, any contact with the barrel will result in heat generation and potential degradation/deformation of the target or barrel. A degraded or deformed target may cause the fusion reaction to fail when it enters the fusion chamber. A degraded or deformed barrel may inhibit the subsequent launch, injection, and/or travel of subsequent targets.

Therefore it is beneficial to ensure that the target travels through barrel 104 substantially without any contact with the walls of barrel 104. Several techniques are disclosed below in order to achieve these and other goals.

As described throughout the specification, methods and systems for transporting a projectile through a barrel having a length are provided. The method includes injecting gas through the barrel wall to generate an air cushion around the projectile and supplying a specified gas pressure to the barrel wall. The barrel wall can contain a multitude of orifices arrayed radially and longitudinally along the barrel wall. As an example, the barrel wall can include a perforated material or a porous media. As examples, the barrel wall can include at least one of arrayed flow orifices, perforated material, porous media, or specialized flow geometries. In an embodiment, the gas flow through the barrel wall is directed in a non-radial direction to induce projectile rotation. The projectile position can be detected and communicated or predicted by a gas control system and in some embodiments, control of the localized gas supply is provided and the pressurized gas supply is provided in a localized region dependent on the position of the accelerating projectile. As an example, the propulsion gas can be supplied in the vicinity aft of the projectile. The geometrical configuration and/or characteristics of the orifices can be varied along the barrel length. Referring to the perforated or porous designs discussed above, the geometrical configuration and/or characteristics of the perforations or the porous media can be varied along the barrel length.

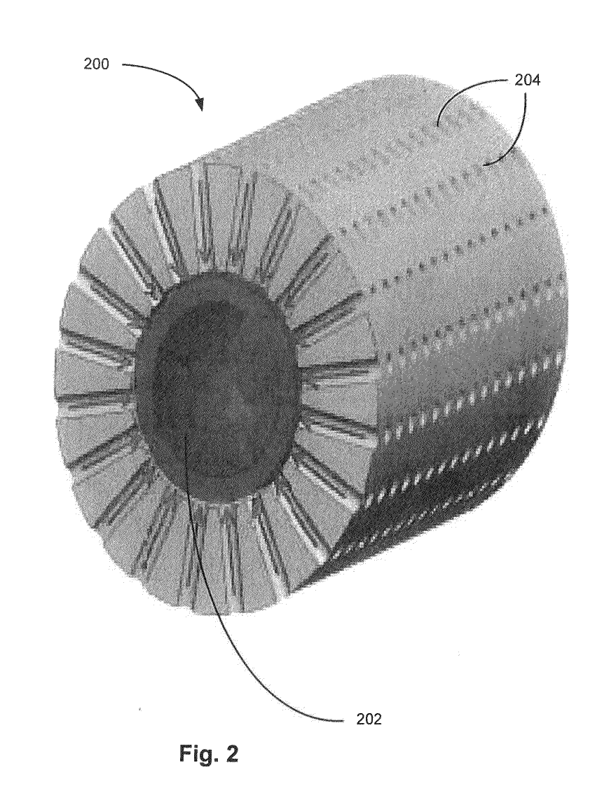

FIG. 2 is a cross-sectional view of a barrel 200 according to an embodiment of the present invention. As illustrated barrel 200 has a perforated design that includes a plurality of through holes 204 that extend from the outer surface of barrel 200 to the inner chamber 202 of barrel 200. The target will travel through inner chamber 202 of barrel 200. In some embodiments, a gas (e.g., air, Nitrogen, Argon, Helium, combinations thereof, or other suitable gas) can be introduced via the through holes 204 to generate a gas cushion inside chamber 202 to enable the target to ride on the gas cushion thereby minimizing friction between the target and the walls of inner chamber 202. Through holes 204 may be placed evenly along the entire length of barrel 200. In some embodiments, through holes 204 may be placed only in certain longitudinal sections along the length of barrel 200. The gas cushion (or gas-bearing) created by introduction of the gas may envelope the target creating a “cocoon” in which the target travels.

There are various mechanisms to create the gas cushion within barrel 200. Some of the mechanisms are described below. It is to be understood, that one or more of the mechanisms described below can be used in conjunction with each other to generate the gas cushion.

In one embodiment, a gas can be continuously flowed at an appropriate rate into barrel 200 via through holes 204. This creates a positive net flow of gas into barrel 200 creating a continuous gas cushion within gas barrel inner chamber 202. When a target is injected into the barrel, the target is partially or completely enveloped by the gas cushion which propels/accelerates the target through the barrel and at the same time eliminates or reduces any contact between the target and the walls of inner chamber 202. In this embodiment, there is a net positive pressure inside the barrel and target travel through the barrel will be influenced by this positive pressure. The pressure value inside the barrel can be designed to be such that it does not slow the target but at the same time maintain the gas cushion inside the barrel.

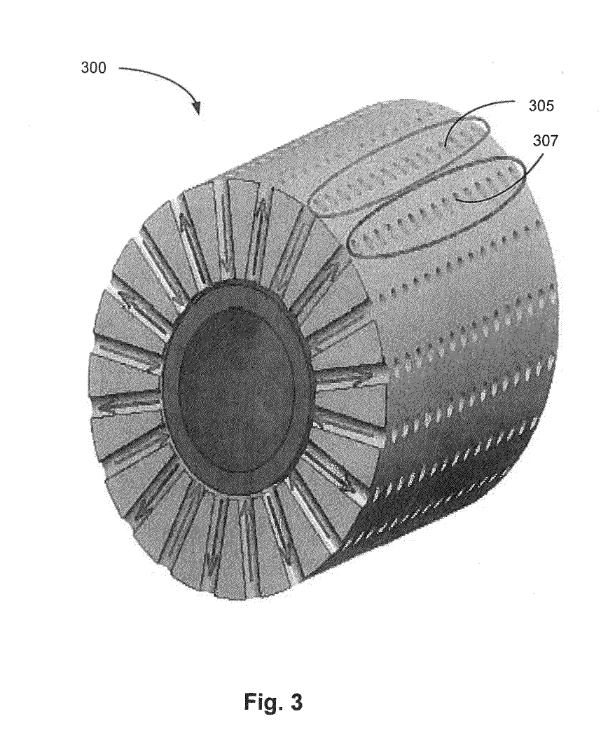

FIG. 3 is cross-sectional view of barrel 300 illustrating another mechanism to generate the gas cushion according to another embodiment of the present invention. In this embodiment, instead of having a continuous flow of gas into barrel 300, some through holes are used to flow gas into barrel 300 and some through holes are used to exhaust the gas from barrel 300. In this embodiment, there is net zero flow of gas since whatever amount of gas is flown into barrel 300 is exhausted out. Using this technique it is possible to create a gas cushion at specific locations along the length of barrel 300. One advantage of this embodiment is that it requires less gas thus reducing cost. Also, in this embodiment, since there is no positive pressure inside the barrel, the target does not encounter resistance that may be present if there was a constant positive pressure inside the barrel.

As illustrated in FIG. 3, embodiments of the present invention provide methods for transporting a projectile through a barrel having a length. In this embodiment, the barrel wall includes orifices 305 that are used to enable gas to flow inward into the barrel to generate an air cushion around the projectile. The barrel wall also includes orifices 307 located at other portions of the barrel wall that are used to enable gas to flow outward to allow exhausting of inter-barrel gas. A supply of pressurized gas is provided (not shown) to supply specified gas pressures to the barrel wall portions.

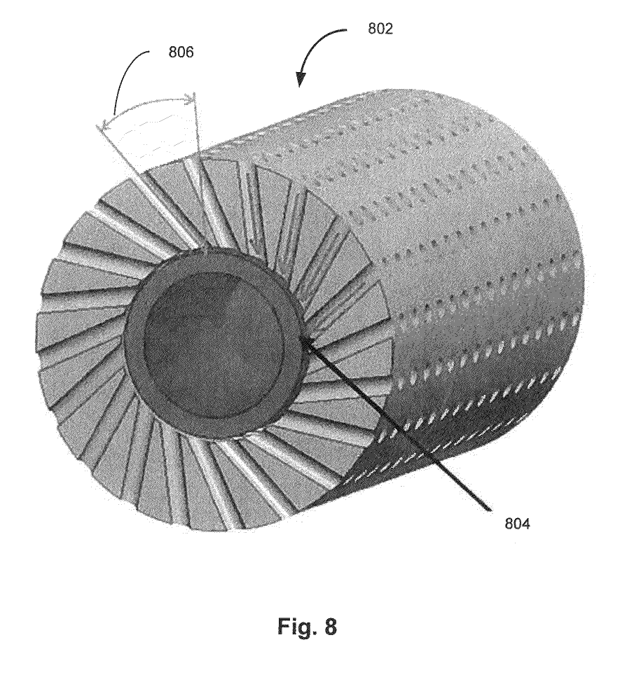

In an embodiment, the barrel wall contains a multitude of orifices arrayed radially and longitudinally along the barrel wall as illustrated in FIG. 3. The barrel wall can include a perforated material, a porous media, combinations thereof, or the like. Thus, embodiments include barrel walls that include at least one of arrayed flow orifices, perforated material, porous media, or specialized flow geometries. In other embodiments, as illustrated in FIG. 8, gas flow through the barrel wall is performed in a non-radial direction to induce projectile rotation.

In some implementations, the projectile position along the length of the barrel is detected and communicated to or predicted by a gas control system and control of the localized gas supply is provided, with the pressurized gas supply being provided in a localized region dependent on the position of the accelerating projectile. In some embodiments, the propulsion gas is supplied in the vicinity aft of the projectile. Additionally, the geometrical configuration and/or characteristics of the orifices can be varied along the barrel length, for example, the geometrical configuration and/or characteristics of the perforations or porous media can be varied along the barrel length.

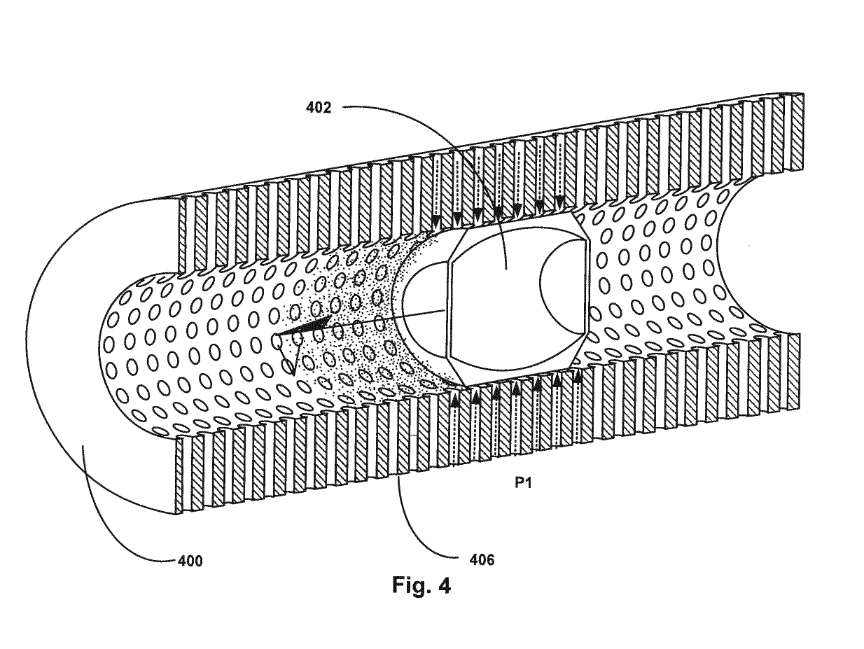

As described above, the gas cushion can be implemented in various ways. FIG. 4 illustrates a cross-section of a barrel 400 that shows a target 402 within the barrel. In this embodiment, the gas cushion is created only at the current location of the target as the target moves through the barrel. In this embodiment, the motion of the target inside the barrel is tracked using a tracking mechanism (not shown). Thus, at any given point of time, the position of the target inside the barrel can be known, The position information can be used to control a gas delivery mechanism (not shown) to flow the gas at that location via the holes 406 creating a localized gas cushion for the target. The presence of gas at that location causes a static pressure that helps to move the target through the barrel. FIG. 4 illustrates a gas cushion being created at a first position where the target is currently located as it travels through the barrel. The pressure at the first location is illustrated as P1. Once the target moves away from the first position to a second position within the barrel (e.g., to the left of location P1), the gas present in first position can be exhausted from the barrel and concurrently gas can be injected into the barrel at the second position. This method can be repeated as the target travels through the barrel until the target exits the barrel. This can be referred to a creating an “on-time” gas cushion as the target travels through the barrel. In practice, because the target is moving through the barrel, it creates a hydrodynamic effect. In some embodiments, the gas can be injected at the first and second positions just prior to the target reaching the first and second position to ensure that a gas cushion exists prior to the target reaching a particular position.

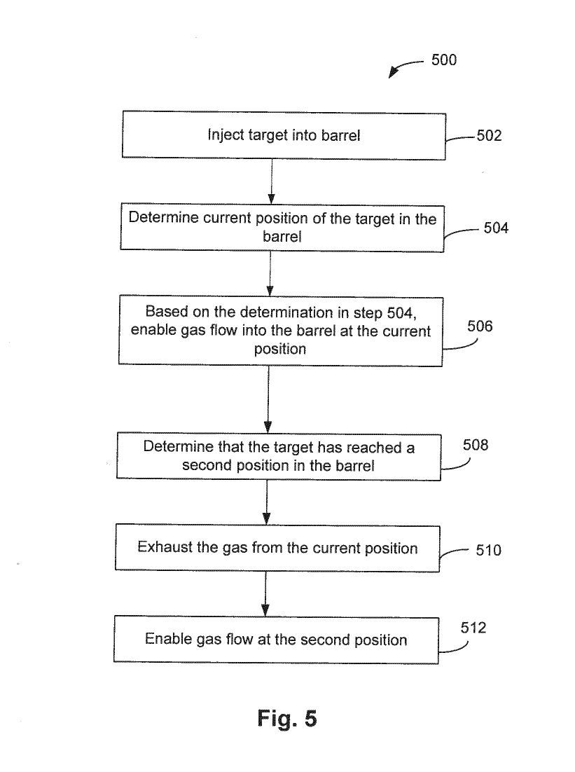

FIG. 5 is a flow diagram of a process 500 for creating a gas cushion according to an embodiment of the present invention.

At step 502, a target is injected into a barrel. The barrel has a certain length and is perforated as described above. At step 504, a current or first position of the target along the length of the barrel is determined. Based on that determination, gas is flown into the barrel via the through holes at the first position creating a gas cushion, at step 506. At step 508, it is determined the target has reached a second position within the barrel. Based on this determination, at step 510, the gas present at the first position is exhausted. Concurrently, at step 512, gas is injected into the barrel at the second position. These steps are repeated for other positions of the target as the target travels through the barrel.

It should be appreciated that the specific steps illustrated in FIG. 5 provide a particular method of transporting a target according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

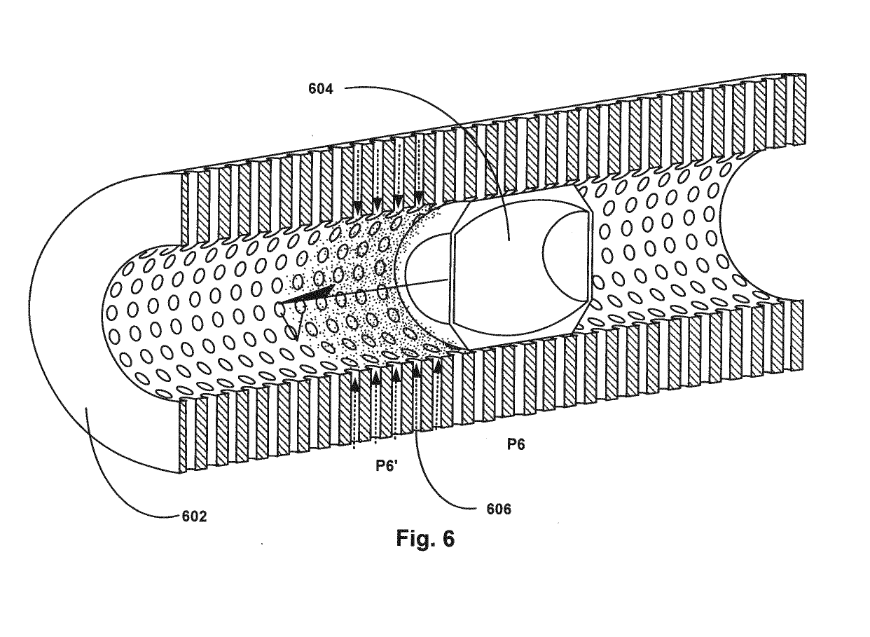

FIG. 6 illustrates a cross-sectional view of a barrel 602 in which the gas cushion is created in front of a target 604 according to another embodiment of the present invention. In this embodiment, the gas flow into the barrel via holes 606 is pre-timed based on determination of travel path and velocity of the target. For example, since the length of the barrel and the velocity of the target is known, it may be possible to estimate the position of the target inside the barrel at any given time. In this example, the target is at position P6 and the gas cushion is created at position P6′ ahead of the travel path of the target. Based on this information, the gas flow can be controlled such that gas is pulsed into the barrel via holes 606 at pre-defined times at locations throughout the length of the barrel to create the gas cushion at or near the actual position of the target at any point as target 604 travels through barrel 602.

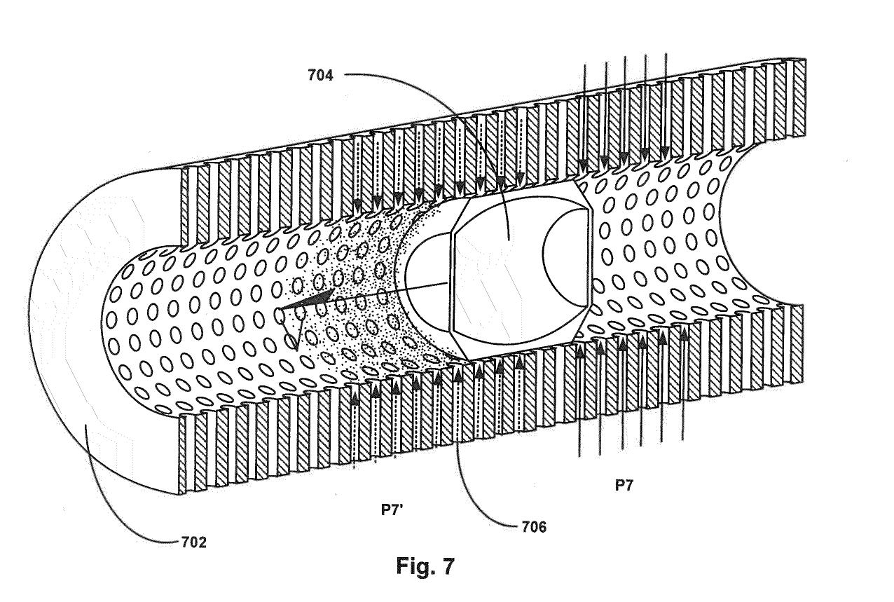

FIG. 7 illustrates a cross-sectional view of a barrel 702 in which a pressure differential is created between the front and back of target 704 according to an embodiment of the present invention. In this embodiment, gas is injected in front of (P7′) and behind (P7) the target 704, thus creating a pressure differential across the target. The pressure differential can be designed such that it provides adequate cushioning effect for the target as well as helps to impart some momentum to the target as it accelerates to its desired velocity.

The gas injected behind that target at location P7 may impede the travel of a subsequent target if it is not exhausted out. In some embodiments, targets are injected into the barrel at the rate of 15-20 targets per second. Thus, it is beneficial in some embodiments to exhaust the gas that is behind a target in a rapid manner so as not to interfere with the travel of a following target.

There are various considerations when designing how much gas to flow into the barrel to create the gas cushion/bearing. In other words, the pressure generated due to the gas flow has to be managed such that the target is centered within the barrel without touching any barrel walls. In some embodiments, the pressure is designed in order to generate a proper restoring force or restoring momentum if the target does get displaced while travelling through the chamber. For example, in FIG. 7, target 704 might get vertically displaced such that it is now closer to or touching the top wall of the barrel. In other words, the gap between the target upper surface and the inner wall of barrel 702 gets smaller and the gap between the target lower surface and the inner wall of barrel 702 gets larger as the target is displaced vertically. This results in increased pressure at the upper surface of the target and decreased pressure at the lower surface of the target. As a result, the increase in pressure at the upper surface is such that it pushes the target downwards and re-centers the target within the barrel.

Similarly, if the target pitches or yaws, a restoring force helps to keep the target centered. For example, the front end of the target may dip downwards causing the back end to rise upwards as the target is travelling. This causes changes in pressure at the front and the back section of the target. The restoring force generated by the pressure differential is enough to straighten out the target. These restoration forces are useful to ensure proper steering of target through the barrel even in the case where some external factors, e.g., vibration, cause movement of the barrel and/or the target.

If the restoring force is not maintained, the target may bump around in the barrel as it travels leaving behind target debris in the barrel. Over time this debris may cause loss or instability of gas flow/pressure within the barrel, thus potentially degrading the gas cushioning effect.

FIG. 8 illustrates a cross-sectional view of a barrel 802 according to yet another embodiment of the present invention. In this embodiment, the through-holes are fabricated such that the grooves that carry the gas into the barrel are angled with respect to radial lines of the barrel. By introducing gas at pre-determined times and location into the barrel, the target can be imparted with a gyroscopic stabilization force that helps to keep the target centered within the barrel. The target can be spun up to a predetermined rate in order to stabilize the target. In this instance, the gas flowing around the target interacts with the targets surface to impart the spinning motion to the target. The amount of spin imparted to the target depends on the pressure generated by the gas inside the barrel, the velocity of the gas, the incidence angle at which the gas flow interacts with the surface of the target, etc. It is to be noted that only some of the parameters affecting the spin of the target are listed below. One skilled in the art will realize that there may be more parameters that affect the spinning motion and stabilization of the target. The gas flow, the angle of the grooves, and the target can be designed to maximize the momentum transfer between the gaps and the target.

In some embodiments, if the outside of the target is smooth around the circumference and there are no surface features on the target for the gas to catch and push on the target, then the viscosity of the gas and the resulting friction between the gaps and the target may impart the spin on the target. Thus, the combination of viscosity and velocity of the gas and width of the gap between the barrel walls and the target determines the amount of spin that can be generated for the target.

The maximum spinning velocity that can be imparted to the target also depends on the time that the target is in the barrel. Since the target is also travelling through the barrel as it is being spun, the amount of time that the target is in the barrel also affects the maximum spin that can be imparted to the target. Thus, given a desired spin rate to be imparted to the target, the barrel length, the gas pressure and velocity, the angle of the grooves and other parameters can be calculated. Another parameter affecting the spin velocity is the temperature of the gas.

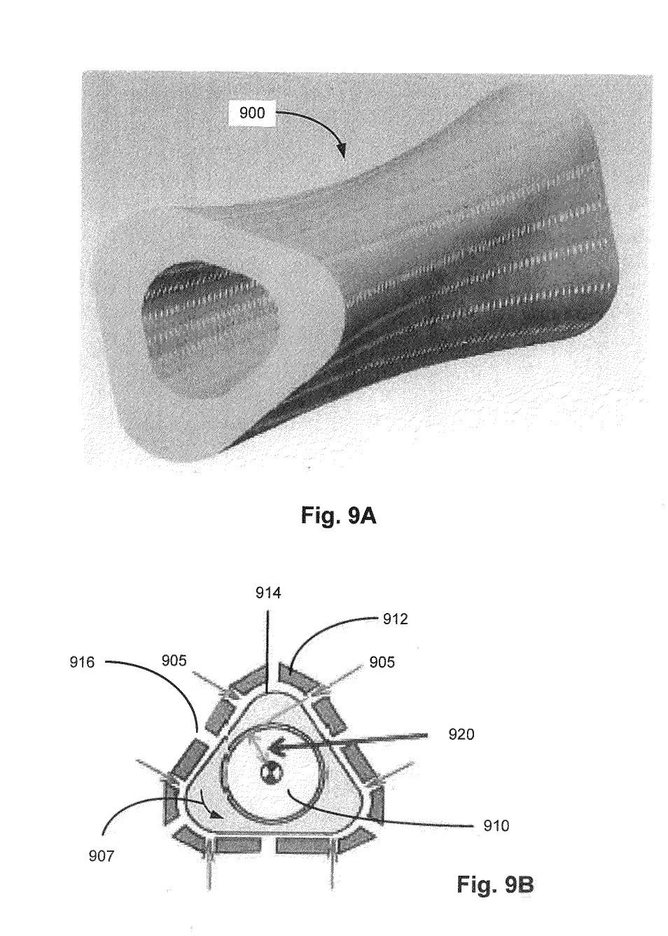

FIG. 9A illustrates a twisted barrel 900 according to still another embodiment of the present invention. Barrel 900 is twisted along its length in a specific manner, for example, the tri-lobe polygonal shape illustrated in FIG. 9A. FIG. 9B illustrates a target 910 as it travels through inner chamber 912 of barrel 900. The triangular element 914 can be part of the target or may be a separate carrier that transports the target 910 through barrel 900. Triangular element 914 follows the contours of the inner chamber of barrel 900 as the barrel twists along its length. In this embodiment, there would be no need for the friction between the gas and the target surface in order to impart the spin on the target. Triangular element 914 will spin as it travels through barrel 900 as it follows the twist along the barrel. One of skill in the art will appreciate that the gas flow imparts spin on the target by producing normal forces on the triangular element 914 that cause the target to follow the twist in the barrel. Thus, the spin can be imparted to the target without the need for the tangential friction between the gas and the surface of the target. Thus, the spin is induced due to the geometry of the barrel and the target. So as the interior geometry of barrel 900 changes along the length of the barrel, target 910, which is illustrated in the triangular element or carrier 914 follows the internal shape change of barrel 900. This motion along with the injected gas imparts a spin on target 910.

In some embodiments, in order to achieve a desired profile of gas film thickness between the target 910 and the barrel 900, gas can be injected selectively via through holes 916. As indicated by arrows 905 in FIG. 9B, the gas can be injected at one or more corners of the triangular element 914 in order to produce a torque 907 to cause it to spin as it follows the twist in the barrel 900. In some embodiments, either the positive net flow or the zero net flow concepts described above can be used to produce a torque 907 on target 910. In some embodiments, barrel 900 is stationary in the twisted state. As illustrated by arrow 920, the gas-bearing sources create force action lines with large moment arms about the target center of mass (represented by the hourglass disc at the center of the target 910), which may not be the geometric center of the target, therefore producing a torque 907. In FIG. 9B, torque 907 (also referred to as a moment) is formed on triangular element 914 that causes it to follow the twist in the barrel (and to prevent the corners of 914 from contacting the barrel as the target progresses down the length of the barrel).

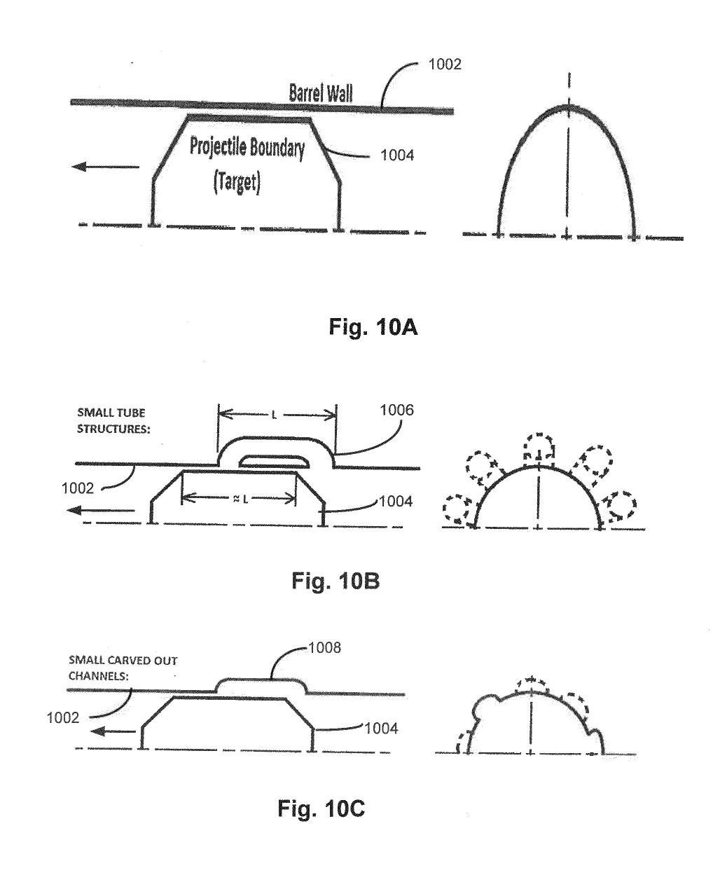

FIGS. 10A-10C illustrate mechanisms to use the propellant gas to generate the gas cushion according to other embodiments of the present invention. Using these techniques may eliminate the need for using an additional gas source for creating the gas cushion.

FIG. 10A illustrates an embodiment where target 1004 is traveling through a barrel. There is a finite gap between the outer surface of target 1004 and barrel wall 1002. As described above, target 1004 may be accelerated within the barrel using a gas gun. The same gas that is used to propel target 1004 can be used to generate the gas cushion around target 1004. The gas can occupy the gap between the target and barrel wall 1002 providing the gas cushion.

FIG. 10B illustrates an embodiment where tubes 1006 can be fabricated along the length of the barrel in order to provide a path for the gas to travel from behind target 1004 towards the front of target 1004 in order to create the gas cushion.

FIG. 10C illustrates yet another embodiment where small channels 1008 are created at specific locations along the length of the barrel to provide a path for the propellant gas to flow around target 1004 to create the gas cushion.

The gas-cushion barrel embodiments described above enable low-friction target barrel travel by preventing target interaction with the barrel wall. This interaction is prevented due to hydrostatic and hydrodynamic effects that create restoring forces and restoring torques to correct perturbations of the target travel down the barrel center-line. Certain parameters affecting gas flow to create the hydrostatic and hydrodynamic gas film low-friction layer may be traded off against each other. For example, parameters effecting gas flow are:
(A) Type of gas and temperature of gas
   Viscosity, shear-rate of the gas
   Gas density, momentum transfer between gas molecules and the target
(B) Barrel flow restriction
   Porous media barrel—permeability, porosity, thickness of media
   Orifice barrel—size, shape, orifice count, choked/non-choked flow
(C) Direction of incoming barrel flow
   Direction of orifice orientation
   Anisotropic permeability of porous media
(D) Target to barrel clearance
   Constant clearance
   Varying clearance along barrel length
   Shape and external features on the target
(E) Gas source pressure
   Constant pressure
   Varying pressure along barrel length
   Method at which the source pressure is controlled
      Travelling pressure pulse
         Pneumatic switching
         Diaphragm actuation
      Large capacitive source, manifold fed
(F) Internal barrel pressure
   Passive pressure regulation via exhaust porous media or orifices
   Active pressure regulation via valves or controlled manifold pressure
   May be affected by having more than one target in the barrel at one time
(G) Barrel exit pressure (barrel exit flow rate)
   Gas scavenging to reduce exit pressure
   Environmental conditions at barrel exit, pressure, temperature, etc.
(H) Barrel diameter
(I) Barrel length
(J) Velocity and acceleration profiles of targets
(K) Mass properties and material properties of the targets
(L) Barrel properties, stiffness, mass, vibration signatures, etc.

Changing the values or methodologies of any of the parameters listed above may have an effect upon the overall performance of the barrel systems described herein. The design of the barrel and surrounding systems can be obtained experimentally and/or through calculations and analyses including Computational Fluid Dynamics (CFD), Fluid-Solid Interaction Finite Element Methods, Non-isothermal Finite Element Methods, total interactions via multi-physics solvers, etc.

In some embodiments, helical or angled characteristics can be applied to any feature for providing a path for the propellant gas to flow around the sides of the target to achieve a gas-bearing effect. Staggered individual features, continuous features, and the adjustment of feature characteristics can be utilized to account for target velocity variation along the barrel length, for instance. As an example, a helical structure could have more turns per meter in lower target velocity regions in the barrel and fewer turns per meter in the peak velocity region. Accordingly, control of the side gas velocity down the barrel can be provided so that the propellant gas can travel around the sides of the target to provide the desired gas-bearing effects, but, in some embodiments, not in front of the target during its travel through the barrel. One of ordinary skill in the art would recognize many variations, modifications, and alternatives.

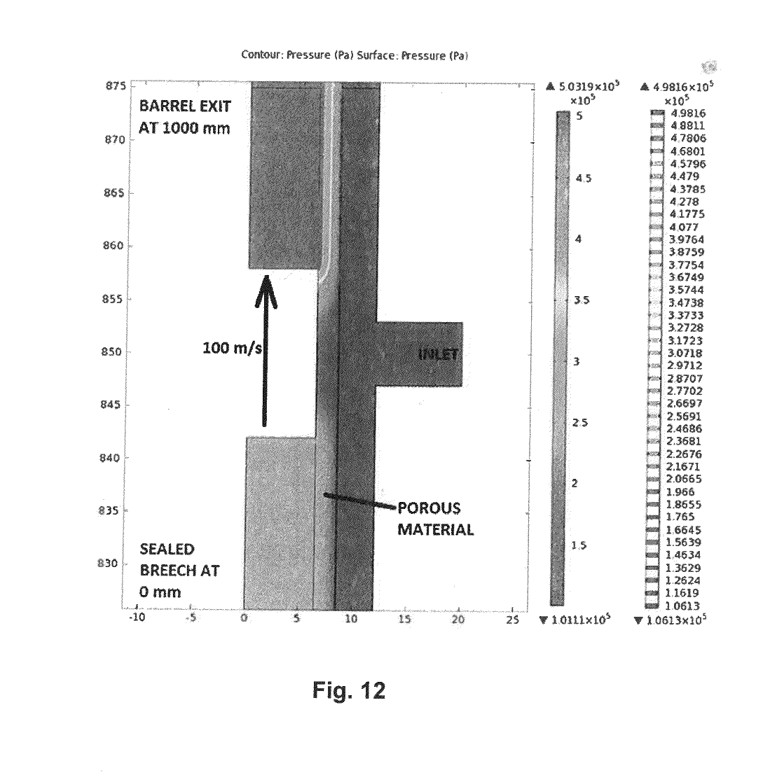

FIG. 12 shows a CFD gas pressure plot of a porous media barrel and target interaction according to an embodiment of the present invention. As illustrated in FIG. 12, the pressure profile along the sides of the target is greater than the propulsion pressure behind the target or the down-barrel pressure ahead of the target. This is accomplished through the proper configuration of some or all parameters described above. An example of a parameter trade-off is now described by pressure distribution around the target in FIG. 12. If Darcy's Law is used to describe the gas flow through the porous media, then that flow is directly related to the surface area of the porous flow region and the pressure differential across the porous media. As the target advances down the barrel, the flow area behind the target increases. This increase in flow area increases the flow rate and therefore the mass of the gas behind the target, which in turn increases the pressure behind the target. This pressure however, also tends to decrease due to the expanding volume behind the target as it advances down the barrel. This interaction between flow rate and volume change due to target velocity is achieved through a balance of parameters described above. If one parameter changes, e.g., the mass of the target increases, then the pressure that once caused one target velocity now cannot achieve the same velocity. The pressure signature behind the target will change now that the volume change due to target velocity no longer maintains the proper balance. So, in conjunction with a target mass increase, permeability of the porous media may need to decrease such that the Darcy Law driven pressure balance is recovered.

However, a decrease in permeability will decrease the restoring force pressure at the barrel wall interaction. To account for this, the source pressure would need to increase. If the gas used enters a transition region from gas to liquid phase at the newly required source pressure, then an increased temperature is required resulting in changed viscosity and flow characteristics. Regardless, reconfiguration of all parameters could be required due to an increase of target mass. In addition to creating the proper linear motion and stability of the target, gyroscopic stabilization for down-range performance may be desired. Angular momentum can be induced in the target using external features on the target, parameters of the barrel gas inflow characteristics, interactions between barrel geometry and target geometry, or a combination of gas flow and target features.

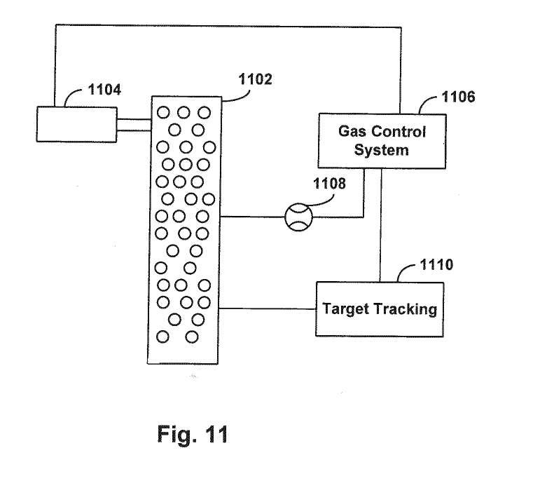

FIG. 11 is illustrates a block diagram of a system for transporting a target through a barrel according to an embodiment of the present invention. The system includes a perforated barrel 1102 coupled to a target injection system 1104. Target injection system 1104 is configured to inject a target into barrel 1102 and provide the propellant gas to accelerate the target as it travels through barrel 1102. The system also includes a gas control system 1106 and regulator 1108 to control the flow of gas for generating the gas cushion for the target. The gas control system may receive inputs from target injection system 1104 and target tracking system 1110 that tracks the target as it moves through barrel 1102. In some embodiments, target tracking system provides the position information about the target that can be used by gas control system to enable gas flow to create localized gas cushion within barrel 1102.

It will be appreciated that the system configurations and components described herein are illustrative and that variations and modifications are possible. Further, while the system above is described herein with reference to particular blocks, it is to be understood that these blocks are defined for convenience of description and are not intended to imply a particular physical arrangement of component parts. Further, the blocks need not correspond to physically distinct components. Blocks can be configured to perform various operations and various blocks might or might not be reconfigurable depending on how the initial configuration is obtained. There may be other components in the system, which are not specifically described herein.

Thus, although the invention has been described with respect to specific embodiments, it will be appreciated that the invention is intended to cover all modifications and equivalents within the scope of the following claims.

What is claimed is:

1. A method for transporting a projectile through a barrel having a length, the method comprising:
inserting the projectile into the barrel; and
flowing a gas into the barrel to generate a gas-film cushion around the projectile.

2. The method of claim 1 further comprising:
detecting insertion of the projectile into the barrel; and
determining that the projectile has reached a first position in the barrel.

3. The method of claim 2 further comprising:
determining that the projectile has reached a second position in the barrel;
exhausting the gas at the first position; and
flowing the gas into the barrel at the second position.

4. The method of claim 3 wherein exhausting the gas at the first position and flowing the gas into the barrel at the second position is performed concurrently.

5. The method of claim 1 wherein the barrel wall comprises at least one of a perforated material or a porous media.

6. The method of claim 1 wherein the air cushion is associated with a pressure gradient along the length within the barrel.

7. The method of claim 1 wherein flowing the gas into the barrel to generate an air cushion around the projectile comprises injecting the gas via holes that are angled with respect to the radial direction of the barrel.

8. A method of transporting an object along a tube structure having a tube wall, the method comprising:
flowing a gas into the tube structure through the tube wall;
generating a gas-film cushion between the object and the tube wall; and
exhausting the gas from the tube structure through the tube wall.

9. The method of claim 8 further comprising monitoring gas pressure as a function of object longitudinal position along the tube structure.

10. The method of claim 8 wherein flowing the gas into the tube structure and exhausting the gas from the tube structure are performed at discrete positions.

11. The method of claim 8 wherein flowing the gas into the tube structure and exhausting the gas from the tube structure are performed at the same positions at different discrete times.

12. A system for accelerating a projectile through a barrel, the system comprising:
a barrel having a wall including gas flow passages operable to communicate gas along an interior portion of the barrel and to create a gas-film bearing; and
a pressurized gas system coupled to the barrel and operable to accelerate the projectile through the barrel.

13. The system of claim 12 wherein the gas-film bearing surrounds the projectile.

14. The system of claim 12 wherein the gas communicated along the interior portion of the barrel is provided by the pressurized gas system.

15. The system of claim 12 further comprising:
a projectile injection system operable to inject the projectile into the barrel;
a projectile tracking system operable to measure a position of the projectile in the barrel; and
a gas control system in fluid communication with the barrel.

16. The system of claim 12 further comprising pressurized manifolds operable to provide additional pressurized gas flow to interior portions of the barrel.

17. The system of claim 12 wherein the pressurized gas system comprises a regulator in fluid communication with the interior portion of the barrel.

18. The system of claim 12 wherein the interior barrel flow passages are angled with respect to the radial direction of the barrel.

19. The system of claim 12 wherein the target injection system comprises a propellant gas source.

20. The system of claim 12 wherein the gas control system is operable to receive inputs from the target injection system and the target tracking system.
